(19) United States
(12) Patent Application Publication
(10) Pub. No.: US 2012/0283901 A1
(43) Pub. Date: Nov. 8, 2012

(54) CONTROL SYSTEM FOR HYBRID VEHICLE

(75) Inventors: Tatsunori NAGURA, Tokyo (JP); Tomohiro SAKURAI, Tokyo (JP)

(73) Assignee: Fuji Jukogyo Kabushiki Kaisha, Tokyo (JP)

(21) Appl. No.: 13/437,796

(22) Filed: Apr. 2, 2012

(30) Foreign Application Priority Data
May 4, 2011 (JP) 2011-083847

(51) Int. Cl. B60W 20/00

(52) U.S. Cl. 701/22; 903/930; 180/65.28; 180/65.265

(57) ABSTRACT

There is provided a control system for a hybrid vehicle. When it is detected that an ignition power supply line has been cut off (that an ignition switch has been switched OFF) during EV travel realized by disengaging a transmission clutch, a self-shut function is stopped while keeping a switching transistor of a self-shut line ON, and the transmission clutch is maintained in a disengaged condition by keeping a transmission clutch actuator energized.

### CROSS-REFERENCE TO EEL TED APPLICATIONS

The present application claims priority from Japanese Patent Application No. 2011-083847 filed on Apr. 5, 2011, the entire contents of which are hereby incorporated by reference.

### BACKGROUND OF THE INVENTION

1. Field of the Invention

The present invention relates to a control system for a hybrid vehicle that includes an engine and a motor and is capable of supplying and cutting off power from the engine via a clutch.

2. Description of the Related Art

In a parallel type hybrid vehicle that travels using power from an engine and a motor, a system enabling selection of either electric travel (EV travel) using only the power from the motor or hybrid travel (HEV travel) using the power from both the motor and the engine, depending on traveling conditions, may be employed. In this type of hybrid vehicle, as disclosed in Japanese Patent Application Publication No. 2006-15875, for example, a clutch (to be referred to hereafter as a “transmission clutch”) is typically provided on a power transmission path of the engine, and during EV travel, the transmission clutch is disengaged in order to reduce engine friction.

The transmission clutch provided on the power transmission path of the engine is often constituted to be capable of mechanical self-engagement without a power supply so that a limp home function, with which travel is secured using an engine output when a malfunction occurs, can be realized. Further, during EV travel, the transmission clutch is set in a disengaged condition by an actuator that is drive-controlled by a control device.

Therefore, when an abnormal situation in which an ignition switch is switched OFF due to an erroneous operation by a driver or an ignition power supply line is disconnected (i.e. a situation in which the ignition power supply line is cut off) occurs during EV travel, a power supply of the control device and the actuator is cut off such that the transmission clutch is mechanically engaged rapidly. When the transmission clutch is engaged rapidly, rapid load variation occurs, and as a result, a transmission may be damaged and rapid variation may occur in the vehicle behavior.

### SUMMARY OF THE INVENTION

The present invention has been designed in consideration of these circumstances, and an object thereof is to provide a control system for a hybrid vehicle with which damage to a transmission and rapid variation in a vehicle behavior can be avoided by preventing rapid engagement of a transmission clutch that transmits power from an engine even when an abnormality occurs in an ignition power supply line during travel using only from a motor while the transmission clutch is disengaged.

On aspect of the present invention provides a control system for a hybrid vehicle that has an engine and a motor and capable of supplying and cutting off power from the engine via a clutch, and includes: a control unit for performing processing corresponding to a pre-stored program on the basis of parameters indicating operating conditions of the hybrid vehicle; an ignition power supply line for supplying a power supply to the control unit via an ignition switch; and a self-shutting unit that maintains a conductive condition of a main power supply line for supplying a power supply to the control unit and an electric load including a clutch actuator that disengages the clutch when the ignition switch is switched ON, and cuts the main power supply line off following a set time when the ignition switch is switched OFF. When the ignition power supply line is detected to be cut off during travel using only power from the motor while the clutch is maintained in a disengaged condition by the clutch actuator, the control unit maintains the main power supply line in the conductive condition by halting a function of the self-shutting unit.

Preferably, the control unit of the control system for a hybrid vehicle maintains the main power supply line in the conductive condition by halting the function of the self-shutting unit until the hybrid vehicle stops or decelerates to a predetermined speed.

Preferably, the clutch of the control system for a hybrid vehicle is a normally engaged clutch interposed between the engine and the motor.

According to the present invention, rapid engagement a transmission clutch that transmits power from an engine can be prevented even when an abnormality occurs in an ignition power supply line during travel using only power from a motor while the transmission clutch is disengaged, and as a result, damage to a transmission and rapid variation in a vehicle behavior can be avoided.

### BRIEF DESCRIPTION OF THE DRAWINGS

FIG. 1 is a schematic diagram showing a drive system of a hybrid vehicle;

FIG. 2 is a block diagram showing a power supply system; and

FIG. 3 is a flowchart showing self-shut control processing.

### DESCRIPTION OE THE PREFERRED EMBODIMENT

An embodiment of the present will be described below with reference to the drawings.

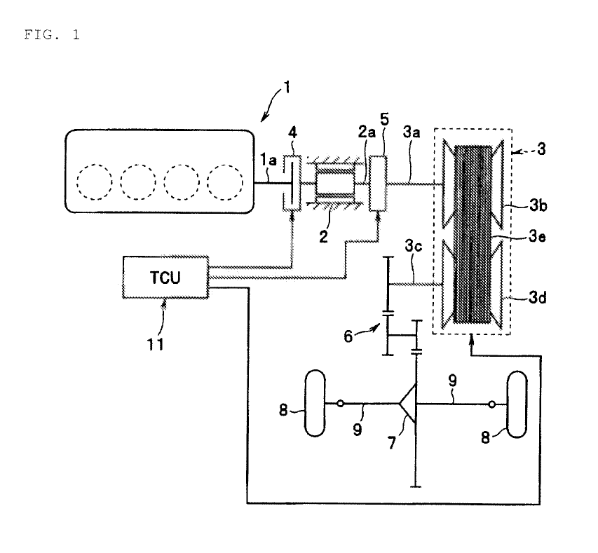

FIG. 1 shows a drive system of a hybrid vehicle that uses at least either one of an engine 1 and a motor 2 as a travel drive source. In the drawing, the engine 1 and the motor 2 are arranged in series, and a transmission 3 is connected to an output side of the motor 2. A clutch (to be referred to hereafter as a “transmission clutch”) 4 that transmits power from the engine 1 is interposed between an output shaft 1a of the engine 1 and a rotary shaft 2a of the motor 2, and a clutch (to be referred to hereafter as a “forward-reverse switching clutch”) 5 that switches between forward and reverse travel is interposed between the rotary shaft 2a of the motor 2 and an input shaft 3a of the transmission 3.

In the drive system of the hybrid vehicle shown in FIG. 1, it is possible to switch between electric travel (EV travel) using only power from the motor 2, in which the transmission clutch 4 is disengaged, and hybrid travel (HEV travel) using power from both the engine 1 and the motor 2, in which the transmission clutch 4 is disengaged. The transmission clutch 4 is a normally engaged clutch configured to be mechanically engaged when not driven by an actuator to be described below. Accordingly, the transmission clutch 4 performs a disengagement operation when driven by the actuator. At this time, driving force from the engine 1 is cut off, enabling travel using only driving force from the motor 2. Note that the motor 2 generates driving force during power running and acts as a power generator during regeneration.

The forward-reverse switching clutch 5 includes a planetary gear mechanism that rotates integrally when an unillustrated forward clutch is engaged such that rotation of the rotary shaft 2a of the motor 2 is transmitted as is, i.e. in a normal rotation condition, to the input shaft 3a of the transmission 3. During reverse travel, an unillustrated reverse brake is engaged such that the planetary gear mechanism rotates in reverse, and as a result, opposite direction rotation reduced to a predetermined speed is transmitted to the input shaft 3a of the transmission 3.

In this embodiment, the transmission 3 is a continuously variable transmission (CVT) including a primary pulley 3b supported rotatably on the input shaft 3a, a secondary pulley 3d supported rotatably on an output shaft 3c disposed parallel to the input shaft 3a, and a wound transmitting unit 3e such as a belt or a chain wound between the two pulleys 3b and 3d. Further, the output shaft 3c of the transmission 3 is connected to a differential device 7 via a reduction gear set 6, and a drive shaft 9 to which drive wheels 8 constituted by either front wheels or rear wheels are attached rotatably is connected to the differential device 7.

Note that the transmission 3 may be a toroidal type CVT that performs shifts by varying a contact radius of a power roller relative to a disc. Further, the transmission 3 is not limited to a continuously variable transmission and may also be a multiple stage transmission. In the case of a multiple stage transmission, forward-reverse switching is achieved by intermeshing inbuilt gears, and therefore the forward-reverse switching clutch 5 may be omitted.

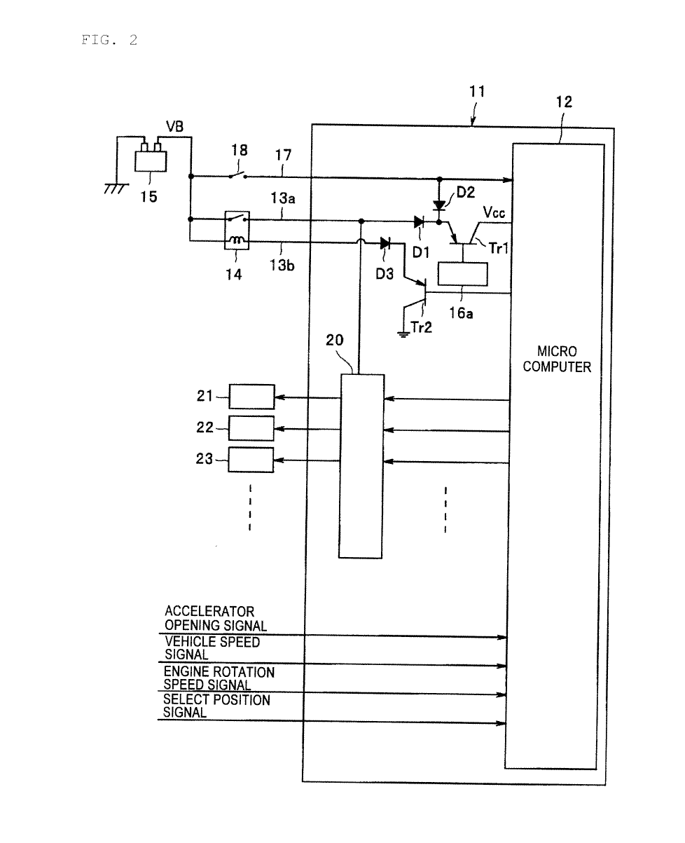

The transmission clutch 4, forward-reverse switching clutch 5, and transmission 3 of the drive system described above are controlled by a transmission control unit (TCU) 11 serving as a control unit that performs processing corresponding to a pre-stored program on the basis of parameters indicating operating conditions of the hybrid vehicle. As shown in FIG. 2, the TCU 11 includes a microcomputer 12 constituted by a CPU, a ROM, a RAM, and so on, and actuators such as various types of valves for controlling oil pressure supplied to the transmission clutch 4, forward-reverse switching clutch 5, and transmission 3 are drive-controlled according to a control program executed by the microcomputer 12.

The TCU 11 is connected to a battery 15 via a main power supply line 13a that feeds a power supply voltage Vcc to the microcomputer 12. A relay contact of a self-shut relay 11 to be descried below is interposed on the main power supply line 13a, and a power supply transistor Tr1 operated by a control circuit 16 is interposed between the relay contact of the self-shut relay 14 and the microcomputer 12.

The power supply transistor Tr1 constitutes a circuit for reducing and stabilizing a battery voltage VB of the battery 15 and generating the power supply voltage Vcc for operating the microcomputer 12. In this embodiment, the power supply transistor Tr1 is constituted by a PNP type transistor. An emitter of the PNP type transistor is connected to the relay contact of the self-shut relay 14 via a backflow preventing diode D1, a collector is connected to the microcomputer 12 side, and a base is connected to the control circuit 16. The control circuit 16 is constituted by a power supply IC or the like, and is used to control a base current of the power supply transistor Tr1, and to adjust/stabilize the battery voltage VB to the power supply voltage Vcc (5 V, for example) at which the microcomputer 12 operates and supply the power supply voltage Vcc to the microcomputer 12.

Further, the TCU 11 is connected to the battery 15 via an ignition power supply line 17 provided in parallel with the main power supply line 13a. An ignition switch 18 that is switched ON and OFF by the driver is interposed on the ignition power supply line 17, and the ignition switch 18 is connected between the backflow preventing diode D1 of the main power supply line 13a and the emitter of the power supply transistor Tr1 via a backflow preventing diode D2.

The self-shut relay 14 will now be described. The self-shut relay 14 forms a main portion of a self-shutting unit that maintains the main power supply line 13a in a conductive condition when the ignition switch 18 is switched ON and cuts off the grain power supply line 13a following a set time when the ignition switch 18 is switched OFF. In other words, the main power supply is not cut off as soon as the ignition switch 18 is switched OFF, and in the meantime, various processing such as storing learned values and the like learned immediately before the ignition switch 18 is switched OFF in a backup memory of the microcomputer 12 is executed.

When the ignition switch 18 is switched ON, the self-shut relay 14 is drive-controlled by the microcomputer 12 such that the relay contact is closed and the main power supply to the TCU 11 is maintained. More specifically, in the self-shut relay 14, one end of a relay coil is connected to the battery 15 and another end of the relay coil is connected to an emitter of a switching transistor Tr2 (a PNP type transistor) via a backflow preventing diode D3 on a self-shut line 13b. A collector of the switching transistor Tr2 is grounded, and a base of the switching transistor Tr2 is connected to the microcomputer 12. Thus, when a current is supplied to the base from the microcomputer 12, the switching transistor Tr2 is switched ON, whereby the relay coil of the self-shut relay 14 is excited such that the relay contact closes.

Various parameters indicating operating conditions of the vehicle, such as ON and OFF signals relating to the ignition switch 18, an accelerator opening signal indicating an opening of an accelerator pedal, a vehicle speed signal indicating a vehicle speed, an engine rotation speed signal indicating an engine rotation speed, and a select position signal indicating a set position of a select lever, are input into an input port of the microcomputer 12. The microcomputer 12 executes calculation processing based on these parameters according to a pre-stored program, and outputs control signals for drive-controlling the various actuators from an output port.

A drive circuit unit 20 for driving the various actuators is connected to the output port of the microcomputer 12. The drive circuit unit 20 includes a buffer, an amplifier, an actuator driving power element, and so on, and is disposed in the TCU 11 in a block form or a dispersed form so as to correspond to the respective actuators. The main power supply line 13a, which bifurcates from a point between the relay contact of the self-shut relay 14 and the backflow preventing diode D1, is connected to the drive circuit unit 20 such that the main cower supply is supplied to electric loads such as the various actuators connected to an output side of the drive circuit unit 20.

The actuators connected to the drive circuit 20 include an actuator (to be referred to hereafter as a “transmission clutch actuator”) 21 for operating the transmission clutch 4, an actuator (to be referred to hereafter as a “forward-reverse switching actuator”) 22 for engaging the forward clutch or the reverse brake of the forward-reverse switching clutch 5, a shift actuator 23 for controlling a shift ratio of the transmission 3, and an unillustrated various other actuators.

The transmission clutch actuator 21 is an actuator for disengaging the transmission clutch 4. As described above, the transmission clutch 4 is a normally engaged clutch, and therefore the transmission clutch 4 is disengaged by switching the transmission clutch actuator 21 ON.

The forward-reverse switching actuator 22 is an actuator for controlling power transmission between the motor 2 and the input shaft 3a of the transmission 3 via the forward-reverse switching clutch 5. When the select lever is set in an N (neutral) range or a P (parking) range, both the forward clutch and the reverse brake of the forward-reverse switching clutch 5 are engaged such that power transmission between the motor 2 and the transmission 3 off.

When the ignition switch 18 is ON and the select lever a forward travel range such as a D (drive) range, the forward-reverse switching actuator 22 engages the forward clutch so that the rotation of the motor 2 is transmitted to the input shaft 3a of the transmission 3 in a normal rotation condition. When the select lever is set in an R (reverse) range, on the other hand, the forward-reverse switching actuator 22 engages the reverse brake so that the rotation of the motor 2 is transmitted to the input shaft 3a of the transmission 3 in a reverse rotation condition reduced to a predetermined speed.

The shift actuator 23 is ON/OFF controlled according to a duty ratio set by the microcomputer 12 to drive a hydraulic control valve provided in a shift control hydraulic circuit. By varying a relative groove width (a winding radius) between the primary pulley 3b and the secondary pulley 3d of the transmission 3, a predetermined shift ratio (primary pulley rotation speed/secondary pulley rotation speed) is set.

Next, control of the drive system by the TCU 11 will be described. In the drive system shown in FIG. 1, for example, EV travel using only the power of the motor 2 is performed during normal travel, whereas HEV travel using the power of both the engine 1 and the motor 2 is performed during high speed travel and high load travel.

when the ignition switch 18 is switched ON during startup, a driving power supply voltage is supplied to the control circuit 16, thereby activating the control circuit 16 such that a predetermined base current is supplied to the base of the power supply transistor Tr1. As a result, the power supply voltage Vcc regulated by the power supply transistor Tr1 is supplied to the microcomputer 12, thereby activating the microcomputer 12.

When the microcomputer 12 is activated, processing is started according to the pre-stored program. First, a predetermined base current is supplied to the base of the switching transistor Tr2 such that the switching transistor Tr2 is switched ON. Accordingly, the relay coil of the self-shut relay 14 is excited such that the relay contact is switched ON (closed), and as a result, the main power supply from the main power supply line 13a is maintained.

Further, a control signal is output to the drive control unit 20 by implementing calculation processing based on the respective parameters input into the microcomputer 12. When the transmission clutch actuator 21 is driven, the transmission clutch 4 in a normal engaged condition is disengaged, and as a result, power transmission between the engine 1 and the motor 2 is cut off such that a travel mode shifts to EV travel using the motor 2.

When the select lever is set in a forward travel range such as the D range or in the R (reverse) range, a power supply voltage is supplied to the forward-reverse switching actuator 22. When the select lever is set in a forward travel range, the forward clutch of the forward-reverse switching clutch 5 is engaged such that a normal rotation operation is performed, and as a result, the rotation of the motor 2 is transmitted to the input shaft 3a of the transmission 3 in the normal rotation condition. When the select lever is set in the R range, on the other hand, the reverse brake of the forward-reverse switching clutch 5 is engaged such that a reverse rotation operation is performed, and as a result, the rotation of the motor 2 is transmitted to the input shaft 3a of the transmission 3 at a predetermined reduced speed.

Further, the shift actuator 23 is ON/OFF controlled by a duty ratio corresponding to the shift ratio (primary pulley rotation speed/secondary pulley rotation speed) set on the basis of the input parameters so as to be energized at a control current value corresponding to the duty ratio, whereby the hydraulic control valve provided in the shift control hydraulic circuit is operated. When the hydraulic control valve is operated, oil pressure (primary oil pressure and secondary oil pressure) supplied to the primary pulley 3b and the secondary pulley 3d is varied such that the relative groove width (winding radius) between the two pulleys 3b and 3d varies.

At this time, the TCU 11 constantly monitors the ON/OFF condition of the ignition switch 18 (the condition of the ignition power supply line 17) using the microcomputer 12, and when the TCU 11 detects that the ignition switch 18 is OFF (the ignition power supply line 17 is cut off) during EV travel following disengagement control of the transmission clutch 4, it is determined that an abnormality has occurred due to an erroneous operation by the driver or disconnection of the ignition power supply line 17. In this case, until the vehicle stops or decelerates to a predetermined speed (decelerates to an extent at which a sudden load is not exerted on the drive system), the relay contact of the self-shut relay 14 is maintained in an ON (closed) condition instead of executing a self-shut operation normally performed when the ignition switch 18 is switched OFF, and the power supply to the TCU 11 is secured such that the transmission clutch 4 is maintained in the disengaged condition for EV travel. In so doing, generation of an excessive shock due to rapid engagement of the transmission clutch 4 is prevented.

In other words, when a malfunction that causes the TCU 11 to stop operating occurs, the transmission clutch actuator 21 can no longer be controlled. Therefore, the transmission clutch 4 is designed to be capable of mechanical engagement in order to realize a limp home function during which travel is performed using the engine 1 alone. Hence, when the ignition switch 18 is determined to be OFF (the ignition power supply line 17 is determined to be cut off) during EV travel, a self-shut function (a function for switching the self-shut relay 14 OFF following the elapse of a set time from the point at which the ignition switch 18 is switched OFF) is activated, thereby cutting off the power supply from the main power supply line 13a to the TCU 11 and the respective actuators including the transmission clutch actuator 21. Accordingly, the transmission clutch 4 is mechanically engaged rapidly such that a sudden load from the engine 1 is exerted on the drive system, and as a result, various parts may be damaged.

Hence, in this system, when the ignition switch 18 is determined to be OFF (the ignition power supply line 17 is determined to be cut off) during EV travel, the self-shut function is halted while keeping the switching transistor Tr2 of the self-shut line 13b ON, and the transmission clutch 4 is maintained in the disengaged condition by keeping the transmission clutch actuator 21 energized. In so doing, the transmission clutch 4 is not rapidly engaged, and therefore a sudden load from the engine 1 is not exerted on the drive system. As a result, rapid load variation can be avoided, and therefore damage to the transmission and rapid variation in the vehicle behavior can be prevented.

When the vehicle stops or decelerates to a predetermined speed (decelerates to an extent at which a sudden load is not exerted on the drive system), the main power supply is cut off by activating the self-shut function, and energization of the transmission clutch actuator 21 is halted such that the transmission clutch 4 is mechanically engaged. In so doing, limp home using only the power from the engine 1 can be initiated.

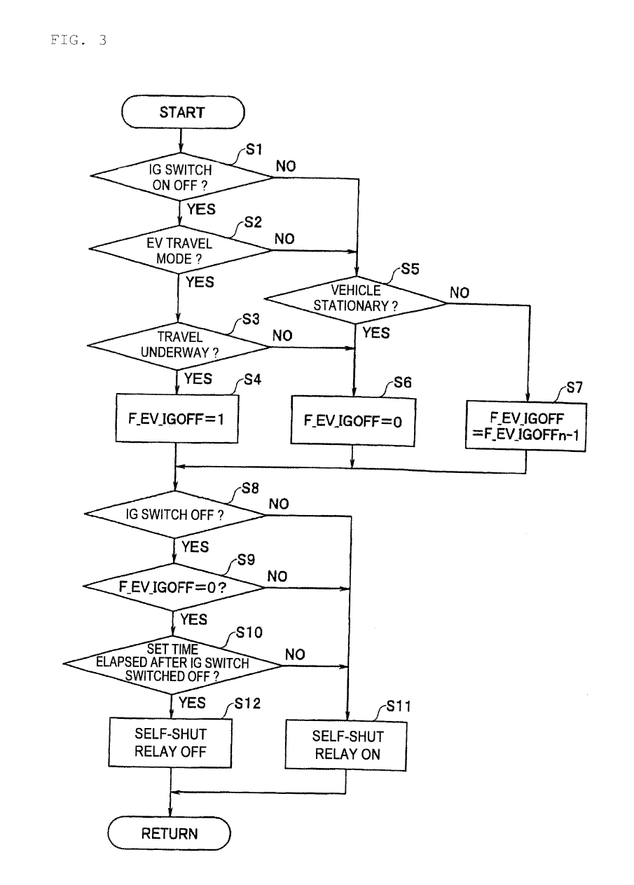

The processing described above is executed by the microcomputer 12 of the TCU 11 as processing of a self-shut control program. Next, the self-shut control processing will be described, using a flowchart shown in FIG. 3.

In the self-shut control processing, first, in Step S1, a determination is made as to whether or not the ignition switch (IG switch) 18 has been switched from ON to OFF. When ON→OFF of the IG switch 18 is detected, a determination is made in Step S2 as to whether or not a travel mode using only the power of the motor (an EV travel mode) is established.

Establishment of the EV travel mode is determined from the condition of the transmission clutch 4, or more specifically an output condition of a signal input into the transmission clutch actuator 21 for disengagement-driving the transmission clutch 4. When the transmission clutch 4 is disengaged or being disengaged, it is determined that the EV travel mode is established, and when the transmission clutch 4 is engaged, it is determined that the EV travel mode is not established.

When the EV travel mode is established in Step S2, the processing advances to Step S3, where a determination is made from the vehicle speed signal and so on as to whether or not vehicle travel is underway. When, as a result, vehicle travel is underway, the processing advances from Step S3 to Step S4, where an IG OFF experience flag F_EV_IGOFF indicating that ON→OFF of the IG switch 18 has been experienced during travel in the EV travel mode is set (F_EV_IGOFF=1). The processing then advances to Step S8 onward. When vehicle travel is not underway in Step S3, the IG OFF experience flag F_EV_IGOFF is cleared (F_EV_IGOFF=0) in Step S6, whereupon the processing advances to Step S8 onward.

On the other hand, when the IG switch 18 has not been switched OFF in Step S1 or the EV travel mode is not established in Step S2, a determination is made as to whether or not the vehicle is stationary in Step S5. When the vehicle is stationary, the IG OFF experience flag F_EV_IGOFF is cleared in Step S6, whereupon the processing advances to Step S8 onward. When the vehicle is not stationary, the IG OFF experience flag F_EV_IGOFF is held at a previous value F_EV_IGOFF n−1 F_EV_IGOFF=F_EV_IGOFF n−1) in Step S7, whereupon the processing advances to Step S8 onward.

Note that the determination as to whether or not the vehicle is stationary in Step S5 is not limited to a vehicle speed of zero, and the determination may be made using a vehicle speed at which a sudden load is not exerted on the drive system upon engagement of the transmission clutch 4 as a threshold.

Step S8 onward is processing for executing or not executing the self-shut function according to a reference result of the IG OFF experience flag F_EV_IGOFF. First, in Step S8, a determination is made as to whether or not the IC switch 18 is OFF. When, as a result, the IG switch 18 is not OFF, the processing advances from Step S8 to Step S11, where the self-shut relay 14 is kept ON (the relay contact is kept closed) by setting the switching transistor Tr2 of the self-shut line 13b in an ON condition such that supply of the main power supply is continued. When the IG switch 18 is OFF in Step S8, on the other hand, the processing advances from Step S8 to Step S9, where the value of the IG OFF experience flag F_EV_IGOFF is referenced.

When F_EV_IGOFF=1 in Step S9, or in other words when ON→OFF of the IG switch 18 has been experienced during travel in the EV travel mode and the vehicle is not stationary, the processing advances from Step S9 to Step S11, where the main power supply is maintained by keeping the self-shut relay 14 ON (keeping the relay contact closed). Hence, when the IG switch 18 is switched OFF during travel in the EV travel mode, the transmission clutch 4 is maintained in the disengaged condition without activating the self-shut function until the vehicle stops. As a result, rapid load variation caused by rapid clutch engagement can be avoided, and therefore damage to the transmission and rapid variation in the vehicle behavior can be prevented.

Note that at this time, the driver is notified of the occurrence of the abnormality by illuminating or flashing a warning lamp provided on an instrument panel or the like, issuing a voice from a speaker, displaying a warning on a monitor, or similar.

When, on the other hand, F_EV_IGOFF=0 in Step S9, the processing advances from Step S9 to Step S10, where a determination is made as to whether or not a set time has elapsed after the IG switch 18 was switched OFF. The set time extends from a point at which the IG switch 18 is switched OFF after the vehicle stops to a point at which the self-shut relay 14 is switched OFF, and serves as a wait time until the self-shut function is activated.

Until the set time elapses in Step S10, the self-shut relay 14 is kept ON (the relay contact is kept closed) in Step S11 such that supply of the main power supply is continued. Once the set has elapsed, the self-shut relay 14 is switched OFF (the relay contact is opened) in Step S12 by switching the switching transistor Tr2 of the self-shut line 13b OFF, thereby cutting of the main power supply. When the main power supply is cut off, the transmission clutch 4 can be mechanically engaged, enabling limp home using only the power from the engine 1.

Hence, according to this embodiment, when the ignition power supply line 17 is determined to be cut off (the ignition switch 18 is determined to be OFF) during EV travel in which the transmission clutch 4 is disengaged by the transmission clutch actuator 21, the self-shut function is halted by maintaining the switching transistor Tr2 of the self-shut line 13b in an ON condition, whereby the transmission clutch actuator 21 continues to operate. As a result, rapid load variation caused by rapid engagement of the transmission clutch can be prevented, whereby damage to the transmission and rapid variation in the vehicle behavior can be avoided.

What is claimed is:

1. A control system for a hybrid vehicle that includes an engine and a motor and is capable of supplying and cutting off power from the engine via a clutch, comprising:
a control unit for performing processing corresponding to a pre-stored program on the basis of parameters indicating operating conditions of the hybrid vehicle;
an ignition power supply line for supplying a power supply to the control unit via an ignition switch; and
a self-shutting unit that maintains a conductive condition of a main power supply line for supplying a power supply to the control unit and an electric load including a clutch actuator that disengages the clutch when the ignition switch is switched ON, and cuts the main power supply line off following a set time when the ignition switch is switched OFF,
wherein, when the ignition power supply line is detected to be cut off during travel using only power from the motor while the clutch is maintained in a disengaged condition by the clutch actuator, the control unit maintains the main power supply line in the conductive condition by halting a function of the self-shutting unit.

2. The control system for a hybrid vehicle according to claim 1, wherein the control unit maintains the main power supply line in the conductive condition by halting the function of the self-shutting unit until the hybrid vehicle stops or decelerates to a predetermined speed.

3. The control system for a hybrid vehicle according to claim 1, wherein the clutch is a normally engaged clutch interposed between the engine and the motor.

4. The control system for a hybrid vehicle according to claim 2, wherein the clutch is a normally engaged clutch interposed between the engine and the motor.
